(19) United States
(12) Patent Application Publication
(10) Pub. No.: US 2025/0053918 A1
(43) Pub. Date: Feb. 13, 2025

(54) OPTIMIZING SUPPLY CHAINS

(71) Applicant: Accenture Global Solutions Limited, Dublin (IE)

(72) Inventors: Sanjoy Paul, Sugar Land, TX (US); Mohamad Mehdi Nasr-Azadani, San Francisco, CA (US); Zaid Tashman, San Francisco, CA (US); Jacob Charles Metzger, San Francisco, CA (US); Maxwell Ryan Murphy, Oakland, CA (US); Aaron Crow, San Lorenzo, CA (US)

(21) Appl. No.: 18/230,901

(22) Filed: Aug. 7, 2023

(51) Int. Cl. G06Q 10/087; G06Q 10/0635; G06Q 30/0202

(52) U.S. Cl. CPC G06Q 10/087; G06Q 10/0635; G06Q 30/0202

(57) ABSTRACT

Methods, systems, and apparatus, including computer programs encoded on computer-storage media, for obtaining inventory data associated with a product or service; generating, using the inventory data, a monotonically increasing function indicative of cumulative demand; predicting future inventory events using the monotonically increasing function and a machine learning model that includes survival curve analysis; in response to predicting future inventory events using the monotonically increasing function of data and survival curve analysis, generating an instruction configured to procure one or more items of inventory; and transmitting the instruction to an inventory system.

### FIELD

This specification generally relates to optimizing and applications of optimizing supply chains.

### BACKGROUND

Supply chain mechanisms can help determine when inventory of various products or services are required to satisfy demand. Stock-out events can occur when a manufacturer's or seller's inventory is not sufficient to satisfy demand for a product or service. Timing of stock-out events are not typically known in advance.

### SUMMARY

In some implementations, techniques described in this document provide a system for inventory management in which likelihood of future stock-out events can be predicted based on historical sales data while accounting for characteristics of the sales data that are not indicative of true demand. In the presence of such characteristics, the sales data can be referred to as “censored” data, which without more, may incorrectly represent true demand, and thereby cause inaccuracies in stock-out predictions The techniques described herein preprocess censored data—by considering sales and inventory data together—to correct for such censoring effects, and apply a parameterized survival analysis in an inventory domain to determine likelihoods of stock-out events within a given timeline with the parameters of the analysis accounting for risk tolerance dictated by particular business policies. Specifically, techniques described in this document provide for a probabilistic modeling system to determine a quantity and timing of past stock-out events which can in turn be processed using a trained machine learning model to determine a likelihood of a given inventory level resulting in a stock-out event within a given timeline. The technology described herein also provides for proactively generating and transmitting communications to connected inventory systems to obtain additional inventory for manufacturing or services to help avoid future stock-out events.

In some implementations, the techniques described herein can also be used to implement a triage process on the sales data to determine suitability of the sales data for a survival analysis as described herein. Specifically, historical sales data over a given time span is analyzed to determine an approximate number and times of inventory stock-outs, and a distribution is determined for the stock-out events over that time span. Timing of stock-out events—as determined from the distribution⇒is used in a survival analysis (referred to as an inner survival analysis) to produce a triage model (e.g., a generative Bayesian model), which in turn can be used to estimate censoring effects of the particular sales data. The censoring effects can be measured, for example, in terms of inventory costs and missed profit opportunities, and used in determining the suitability of using survival analysis for the given sales data.

Advantageous implementations can include one or more of the following features. By preprocessing sales or other use data to account for censoring effects, the data can be converted into a form that is an unbiased indicator of true demand. Using such data in a survival curve analysis in a context-specific domain (e.g., the inventory domain in the context of inventory management) can potentially avoid inefficient cycles of over-stocking and under-stocking resulting from inaccurate estimates of true demand. This in turn can provide for efficient inventory management. In addition, by parameterizing the survival analysis, policies and risk tolerances of individual entities can be taken into account making the technology described herein customizable for various applications and scenario.

In general, one aspect of the subject matter described in this specification can be embodied in methods that include the actions of obtaining inventory data associated with a product or service; generating, using the inventory data, a monotonically increasing function indicative of cumulative demand; predicting future inventory events using the monotonically increasing function and a machine learning model that includes survival curve analysis; in response to predicting future inventory events using the monotonically increasing function of data and survival curve analysis, generating an instruction configured to procure one or more items of inventory; and transmitting the instruction to an inventory system.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. For example, in some implementations, inventory events include a stock-out event in which an inventory level fails to satisfy a threshold condition. In some implementations, actions include generating, using the inventory data, past stock-out event predictions, where the past stock-out event predictions comprise a time value indicating when a past stock-out event occurred. In some implementations, predicting future inventory events using the monotonically increasing function of data and the machine learning model that includes survival curve analysis includes: providing the past stock-out event predictions to the machine learning model trained to determine a likelihood of future stock-out events.

In some implementations, actions include determining to generate the instruction configured to procure the one or more items of inventory. In some implementations, actions include generating, using output from the machine learning model, a likelihood of a future stock-out event for a period of time in the future; and comparing the likelihood of a future stock-out event for the period of time in the future with a user-defined target likelihood, the target likelihood being indicative of an associated risk tolerance level, wherein determining to generate the instruction configured to procure the one or more items of inventory includes: determining the likelihood of a future stock-out event for the period of time in the future is higher than the target likelihood.

In some implementations, actions include providing a user interface indicating a likelihood of a future stock-out event for a period of time in the future and a risk tolerance level provided by a user; obtaining input from the user interacting with the user interface indicating a change in the period of time; and updating the user interface indicating the cumulative likelihood of a future stock-out event for the changed period of time in the future and the risk tolerance level provided by the user.

In general, another aspect of the subject matter described in this specification can be embodied in methods that include the actions of obtaining sales data from over a time span, the sales data pertaining to an inventory associated with a product or service; determining, from the sales data, a number of stock-out events in the inventory and the corresponding timing of the stock-out events, each of the stock-out events being an event in which the inventory fails to satisfy a threshold condition; determining a probability distribution representing a distribution of the stock-out events; estimating adjusted time locations of the stock-out events based on the probability distribution, the adjusted time locations accounting for one or more censoring effects of the sales data; generating, based on the adjusted time locations of the stock-out events, a model that accounts for one or more censoring effects of the sales data; and determining, based on the model, one or more parameters representing the one or more censoring effects of the sales data.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. For example, in some implementations, determining the probability distribution representing the distribution of the stock-out events includes using one or more hyperprior distributions to determine the probability distribution.

In some implementations, estimating the adjusted time locations of the stock-out events includes determining a time period between at least two of the stock-out events. In some implementations, the probability distribution includes at least one of an exponential distribution or a Poisson distribution. In some implementations, determining the probability distribution includes adjusting one or more parameters of the probability distribution based on user-input.

In some implementations, the model includes a generative Bayesian model. In some implementations, the model is adjusted based on additional sales data. In some implementations, the model is adjusted based on additional sales data using techniques that include at least one of (i) Markov Chain Monte Carlo technique or (ii) Variational Inference. In some implementations, the model includes a posterior distribution representing a corresponding quantity of interest. In some implementations, the corresponding quantity of interest is one of (i) a number of the stock-out events, (ii) a timing of the stock-out events, or (iii) an estimate of a true demand during the time span.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for optimizing supply chains.

FIG. 2 is a visualization of a threshold system for optimizing supply chains.

FIG. 3 is a flow diagram illustrating an example of a process for automatically adjusting manufacturing or service inventory.

FIG. 4 is a flow diagram illustrating an example of a process for optimizing supply chains.

FIG. 5 is a diagram illustrating an example of a computing system used for automatically adjusting manufacturing or service inventory or optimizing supply chains.

Like reference numbers and designations in the various drawings indicate like elements.

### DETAILED DESCRIPTION

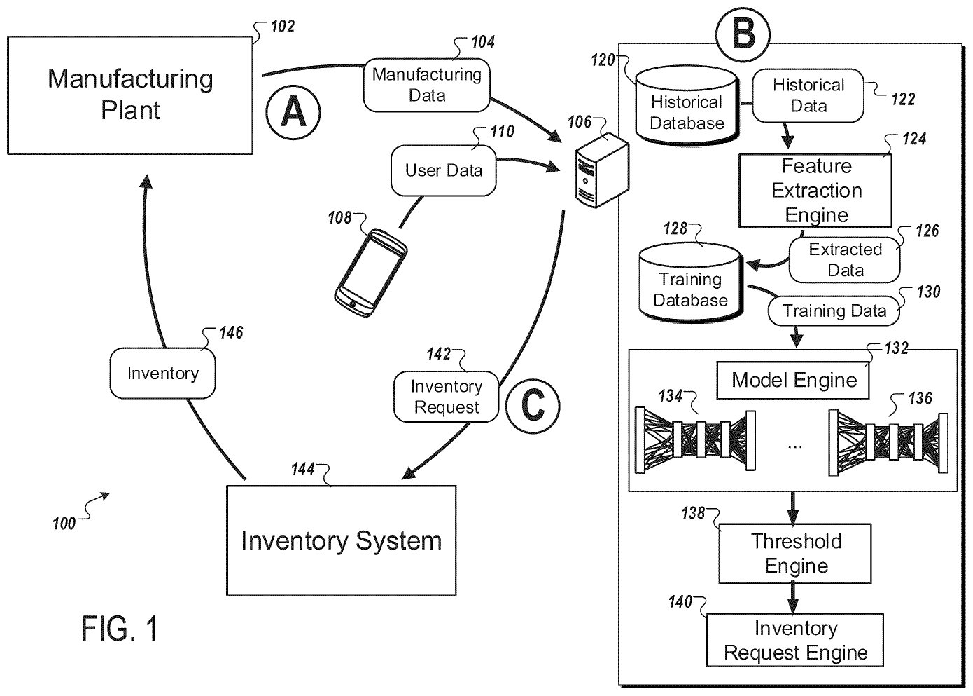

FIG. 1 is a diagram showing an example of a system 100 for optimizing supply chains. The system 100 includes a manufacturing plant 102, a control unit 106, and an inventory system 144. The control unit 106 obtains manufacturing data 104 from the manufacturing plant 102. The manufacturing plant 102 can include one or more connected components that operate to manufacture one or more articles—e.g., smartphones, clothing, electronics, food, among others. The inventory system 144 can include one or more connected components that provide inventory to the manufacturing plant 102. The manufacturing plant 102 can use the inventory provided by the inventory system 144 to manufacture one or more articles.

In stage A, the control unit 106 obtains manufacturing data 104 from the manufacturing plant 102. In some implementations, one or more components of the manufacturing plant 102 transmit signals to the control unit 106 where the signals are sent over a wired or wireless network and represent the manufacturing data 104. In some implementations, the manufacturing data 104 includes transaction data. For example, the manufacturing data 104 can include a date and time of a transaction (e.g., a customer request for one or more articles generated by the manufacturing plant 102), a stock-keeping unit (SKU) identifier (or other unique identifier of manufactured item), and a number of articles sold in a transaction. In some implementations, the manufacturing data 104 includes inventory data. For example, the manufacturing data 104 can include data representing a time of inventory stock-outs. This data can be in a raw or unprocessed form, e.g., spreadsheet, java script object notation (JSON), production database, among others.

In stage B, the control unit 106 processes the manufacturing data 104. In some implementations, the control unit 106 stores the manufacturing data 104 in an historical database 120. The historical database 120 can include manufacturing data from a period of time prior to a current time and can include the manufacturing data 104 obtained from the manufacturing plant 102.

In some implementations, the control unit 106 includes one or more processors. The one or more processors can perform one or more operations including those described in reference to a feature extraction engine 124, a threshold engine 138, or an inventory request engine 140. As used herein, the term “engine” refers to a set of computing/programmatic instructions, that when executed by a data processing apparatus (e.g., a processor), result in the performance of certain operations associated with the underlying component (e.g., the feature extraction engine 124, the threshold engine 138, or the inventory request engine 140).

In some implementations, the feature extraction engine 124 processes manufacturing data, in the form of historical data 122, from the historical database 120. In some implementations, the historical data 122 includes accumulated sales for one or more articles manufactured by the manufacturing plant 102. For example, the feature extraction engine 124 can transform an historical ledger of transactions into an aggregation of sales data over units of time (e.g., hours, days, or weeks). In some implementations, the feature extraction engine 124 corrects for data quality issues, such as missing or incomplete data.

Examples of data quality issue correction that can be performed on historical data (including transaction data) can include: identifying and removing incorrect or erroneous data; repairing or salvaging corrupted records; record deduplication; scrubbing or removing sensitive data for privacy or compliance; correcting structural errors or mismatches between data sources; or aligning multiple event streams into a single account of events.

In some implementations, the manufacturing data of the historical database 120 includes time-series data. For example, the manufacturing data can include point-in-time information representing transactions, inventory, or other manufacturing data. In some implementations, the feature extraction engine 124 generates covariates in generated extracted data, such as extracted data 126. The feature extraction engine 124 can extract features such as daily, weekly, or monthly lags; covariates or features from two or more SKUs (in a case where the historical database 120 includes data of two or more articles of manufacture); exogenous data (e.g., sales location, customer demographics, weather conditions, information about relevant advertisement campaigns, among others).

In some implementations, lag indicates the forward propagation of a time series representation into one or more row-based data samples where each row includes replications of “lagged” data points (e.g., earlier data points). For example, below is an example time series:

| Time | 1 | 2 | 3 | 4 | 5 | 6 | 7 | 8 | 9 |
|---|---|---|---|---|---|---|---|---|---|
| Value | 0.1 | 0.3 | 0.2 | 0.4 | 0.5 | 0.1 | 0.7 | 0.3 | 0.1 |

The feature extraction engine 124 or other component shown in FIG. 1 can transform the example time series into a set of row-based examples, e.g., with three lag values:

| Time | Value | Lag-1 Value | Lag-2 Value | Lag-3 Value |
|---|---|---|---|---|
| 1 | 0.1 | None | None | None |
| 2 | 0.3 | 0.1 | None | None |
| 3 | 0.2 | 0.3 | 0.1 | None |
| 4 | 0.4 | 0.2 | 0.3 | 0.1 |
| 5 | 0.5 | 0.4 | 0.2 | 0.3 |
| 6 | 0.1 | 0.5 | 0.4 | 0.2 |
| 7 | 0.7 | 0.1 | 0.5 | 0.4 |
| 8 | 0.3 | 0.7 | 0.1 | 0.5 |
| 9 | 0.1 | 0.3 | 0.7 | 0.1 |

In some implementations, the feature extraction engine 124 splits data into one or more groups. For example, the feature extraction engine 124 can split the historical data 122 into J intervals where J can vary depending on implementation and output the assigned data elements in the extracted data 126. The choice of these intervals can be set a priori or computed adaptively according to data at hand—e.g., available in the historical database 120.

In some implementations, each interval represents a censoring event—e.g., where inventory of a service or product was insufficient to meet demand. Generally, a censoring event can distort determinations made from data. Without correction, these distortions can result in inaccurate determinations leading to inaccurate downstream processes—e.g., procuring more or less inventory than is required. In an example case, using sales data as a proxy for demand will underestimate the resulting demand when inventory of a service or product was insufficient to meet demand. Often, censoring events are not recorded—e.g., only sales made are recorded. To correct for the distorting effect of this censoring, the system 100—e.g., the feature extraction engine 124—can predict censoring events to correct a resulting cumulative demand function to be used for future stock-out predictions.

A censoring event can include stock-out events representing a time when inventory is insufficient to meet demand for a good-such as a good manufactured by the manufacturing plant 102—or service. In an example, data from the historical data 122 that is included in an interval after a first stock-out event but before a second stock-out event can be included in an interval corresponding to the second stock-out event. In this way, all data from the historical data 122 can be assigned to an interval.

In some implementations, intervals for which data is assigned by the feature extraction engine 124 correspond to piecewise exponential functions. The piecewise exponential functions can be used to generate a hazard function for which a machine learning model is trained to predict, as described in this document. The feature extraction engine 124 can generate and include a flag or indication for each data element of the extracted data 126 indicating an interval which the data element belongs. The indication can be included as an additional column or field depending on a structure of the extracted data 126.

In some implementations, the feature extraction engine 124 can generate and include an offset count. For example, in addition to the sales occurring at the given time unit or within a period of time corresponding to a censoring event, the feature extraction engine 124 can generate and include a representation of a distance from a lower bound of an interval (e.g., a starting time or sale number indicating a first censoring event as an exclusive bound, or a subsequent time or sale number as an inclusive bound). This can be analogous to a piecewise “exposure time” in a piecewise constant hazard function in an epidemiological case. In some implementations, the J intervals are not explicitly modeled in a hazard function. Rather, a trained machine learning model or models learn a total piecewise function from piecewise components, as described in this document.

In some implementations, the feature extraction engine 124 includes additional state information relevant to one or more SKUs represented in the historical data 122. For example, the feature extraction engine 124 can obtain data from other data sources and combine the data with data from the historical data 122 to generate the extracted data 126. Other data sources can include Internet sources, such as weather data, data from sales sites, additional data streams provided by elements of the manufacturing plant 102, among others. Additional state information can be combined with data of an interval to provide additional data which can be used by a machine learning model to help predict future inventory adjustments required based on past use of inventory.

Additional state information can be included in the extracted data 126, e.g., as a column or other element of data depending on format of the extracted data 126. Examples of additional state information can include qualitative ripeness or age of perishable or volatile products or whether an SKU is “featured”, “on sale”, or “in clearance”.

In some implementations, the manufacturing data 104 includes indications of stock-out events. For example, the manufacturing data 104 can include one or more data elements indicating that a stock-out occurred and corresponding data at the time of the stock-out (e.g., a requested amount of inventory not satisfied, a level of inventory, among others). In some implementations, the control unit 106 obtains additional data. For example, the control unit 106 can obtain additional data from the device 108. The additional data can include the user data 110. The user data 110 can include an indication of timing of one or more events, such as stock-out events. If events are not known, the feature extraction engine 124 can predict events based on the historical data 122—e.g., using one or more trained models, such as a generative Bayesian model or other models, or optimal switch point detection—e.g., detecting points at which data transitions from uncensored to censored or vice versa. The predicted events can be confirmed by a user or directly included in the extracted data 126.

In some implementations, the feature extraction engine 124 provides the extracted data 126 to a training database 128. In some implementations, the feature extraction engine 124 provides extracted data 126 directly to a model engine 132 as the training data 130. The model engine 132 can train one or more models to predict one or more stock-out events or risk of stock-out events in the future. Using predictions from trained models, the control unit 106—e.g., threshold engine 138 and inventory request engine 140—can transmit signals to adjust one or more inventories to prevent stock-out events for one or more articles of manufacture or a type of service in an implementation where services are analogous to manufactured inventory.

In some implementations, the control unit 106 processes manufacturing data to generate training and testing data. For example, the control unit 106 can generate training data to be used by the model engine 132 for training one or more machine learning models (e.g., first model 134 and second model 136). The control unit 106 can generate testing data to be used by the model engine 132 to test the one or more machine learning models. A testing phase can be used to assess the generalizability and performance of a model before deployment—e.g., use by the threshold engine 138 and inventory request engine 140.

In some implementations, the model engine 132 generates trained models 134 and 136 using the training data 130. The model engine 132 can obtain the training data 130 from the feature extraction engine 124 or from the training database 128. The model engine 132 can generate models that predict inventory level using manufacturing data (e.g., sales data) even when events like stock-out are not explicitly tracked—e.g., stock-out events can be predicted and added to training data by the feature extraction engine 124.

In some implementations, the model engine 132 trains one or more machine learning models to approximate a function—e.g., a hazard function or a survival function. Hazard and survival functions can be similar to use in epidemiological applications except the monotonically increasing function can be represented by manufacturing data instead of time-based data. For example, the feature extraction engine 124 can generate a monotonically increasing dataset of sales data indicating demand for one or more articles of manufacture—or service—depending on implementation.

In some implementations, the feature extraction engine 124 generates a monotonically increasing dataset of sales data indicating demand for one or more articles of manufacture using cumulative sales data. For example, the feature extraction engine 124 can combine indications of demand, such as sale transactions or decreased inventory from sales, over time—e.g., to generate a monotonically increasing dataset indicate accumulation of sales.

While demand is can be measured instantaneously or over a period of time, hazard and survival functions require a monotonically increasing function. Because demand can rise and fall over time, demand is not natively well suited to hazard and survival functions. For some hazard and survival functions, the monotonically increasing function is time (e.g., in the case of predicting survival rates of patients over time). To adapt the methods of hazard and survival functions to the manufacturing and, generally, inventory management domain, the control unit 106 can generate a monotonically increasing measure of demand—e.g., a cumulative function based on sequential addition of values proportional to an amount of items purchased or currency amount in transactions.

The control unit 106 determines an amount of inventory on hand before or after a predefined failure event (e.g., inventory stock-out) using the extracted data 126 generated by the feature extraction engine 124. Unlike some existing applications of survival analysis, the control unit 106 does not generate time-based survival models—e.g., models for predicting time until a failure event. Rather, the survival models discussed in this document are inventory-based. Unlike a time based model that allows predictions based on a current time for factors primarily affected by time, an inventory-based model allows for predictions based on a current inventory level and is well suited for factors that are primarily inventory dependent. For example, a time-based model would not account for the effects of inventory in satisfying orders or the effect of surplus inventory on storing costs and spoilage. In contrast, by generating and using an inventory-based model, the control unit 106 and the system 100 generally, can predict events in the future using a current inventory level as input.

An inventory survival function for total (e.g., accumulated) sales allows, e.g., an inventory manager to determine tradeoffs between keeping inventory level low to save costs and having sufficient inventory to satisfy requests for inventory, subject to uncertainties.

In some implementations, the model engine 132 trains a model for generating predictions of an inventory survival function. For example, the model engine 132 can provide historical data, in the form of the training data 130 to an untrained machine learning model—e.g., fully connected model, convolutional network, among others. The untrained model can predict an event—e.g., stock-out event. The model engine 132 can obtain a prediction and adjust the model to increase accuracy of the model for predicting events, such as stock-out events.

In some implementations, the model engine 132 trains a model for generating predictions of a hazard function. A hazard function can include output of an instantaneous rate of failure (e.g., h(x), where h is the hazard function and x is inventory. A time-based hazard functions h(t) represents an instantaneous likelihood rate of failure at a given time t which can be used to generate a probability for a given period of time Δt. The function, in time, can be defined to compute the instantaneous risk that an event of interest may occur (within a small time interval, Lt), e.g.,:

$$h ( t ) = {lim}_{Δ t \to 0} \frac{Pr \{ ( t < {T}_{1} \leq t + Δ t \vert {T}_{1} > t ) \}}{Δ t}$$

where the nominator denotes the probability that a subject's survival time T1 will be between the time interval t and t +Δt given that they have ‘survived’ up to t, i.e. T1≥t. An expression of h(t)dt approximates the conditional probability that some failure event (e.g., death) occurs in an interval [t, t+dt] given that it has not happened before then.

A hazard function does not exactly produce a probability value but rather an instantaneous ‘rate’ of probability. As an example, one can think of reading velocity reported by speedometer in a car (vs. total traveled distance in current trip). Since, by definition, hazard function is conditioned on the survival up to time t, it is also referred to as ‘conditional failure rate’. Similar to a survival function, a hazard function is strictly non-negative, i.e., h(t)≥0. Also, in contrast to survival function, h(t) can take unbounded and positive values, e.g., h(t) ∈ [0, ∞).

However, as noted in this document, time-based modeling is not as well suited to supply chain improvement as inventory-based modeling. Rather than using time, the model engine 132 can train one or more models for generating predictions of a hazard function based on inventory as an input. For example, h(n)dn (where h() is the hazard function and n represents an amount of inventory—e.g., amount of service available or manufactured products generated by the manufacturing plant 102) can represent a conditional probability that a failure event (e.g., a stock-out) occurs given that larger inventory levels have not stocked out. For example, given that an inventory level of 30 units has not stocked out at the end of period T, a model trained to approximate a hazard function based on inventory can compute the probability that an inventory level of 29 units will stock out.

In some implementations, the control unit 106 generates a curve or function that represents a tradeoff between a likelihood of a stockout event and requisite inventory level. For example, the control unit 106 can determine a probability corresponding to a given inventory level. A probability for any given inventory level can be queried using the generated curve or function that represents a tradeoff between a likelihood of a stockout event and requisite inventory level.

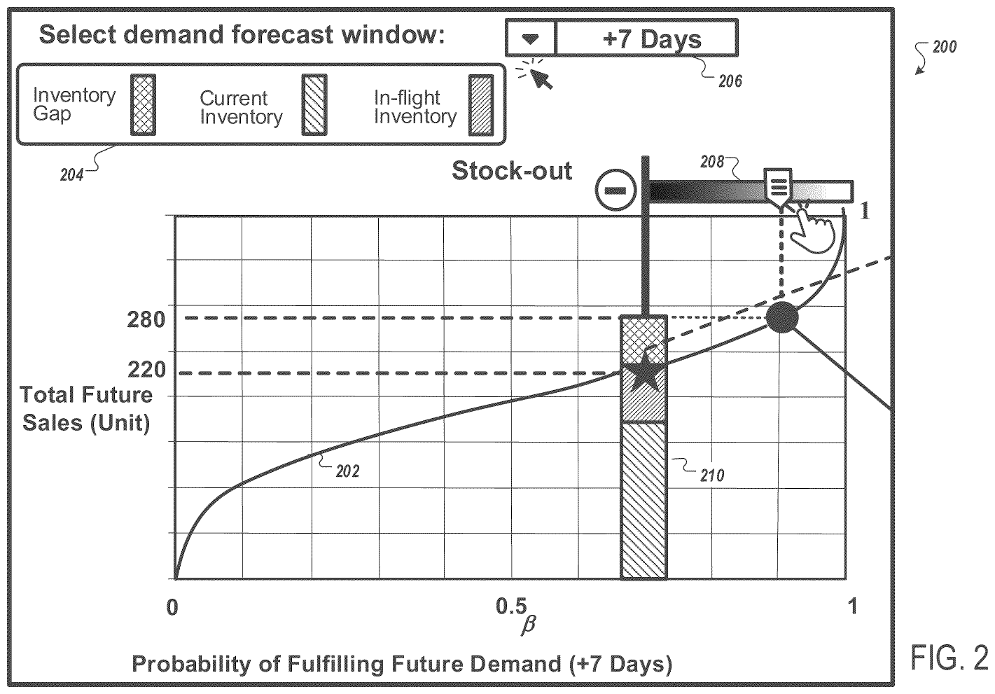

In some implementations, the probability that an inventory level will stock out is with reference to a prediction window or replenishment cycle chosen for analysis. For example, as shown in FIG. 2, the window can be 7 days, such as the next 7 days. In some implementations, survival analysis does not calculate which day among those days are likely to be a stock out but rather the probability that a stock will occur during determined window—e.g., 7 days or other time frame.

The inventory hazard function can be represented as h(n|x(n, t, k), t, k)=exp(g (x(n, t, k), n, t, k)) where g represents a general function of sales n, t represents time, k represents a state (e.g., time of year, weather, on sale data, among others), and x represents a covariate vector x that may also depend on n, t, and k.

In some implementations, a model generated by the model engine 132 estimates output of an inventory hazard function. For example, a model can estimate output of an inventory hazard function by fitting an ML model with a Poisson log-likelihood, or other method, using the training data 130 as input and output as the existence—or count—of stock-out events in an inventory interval corresponding to n.

In some implementations, a model generated by the model engine 132 estimates output of an inventory survival function. For example, the model engine can generate a model, or algorithm, that integrates over a hazard function. The model, or algorithm can generate a negative exponential, where the domain of interest is in sales of a service or product of manufacture domain, represented by n, instead of a time domain. An inventory survival function can be represented as follows:

$$\hat{S} ( n \vert x ( n , t , k ) , t , k ) = exp ( - \int h ( n \vert x ( n , t , k ) , t , k ) dn ) = exp ( - {\sum }_{j = 1}^{j ( n )} h ( x ( {n}_{j} , t , k ) , t , k ) * {\tilde{n}}_{j} )$$

where j(n) is an interval index containing n and ñⱼ is an inventory count in an interval j. If j<j(n) then this is the entire interval; if j=j(n) then this is the offset of n into j(n)).

In general, if j is not the last interval (that is, if j<J(n) where J(n) is the last interval), then the control unit 106 can include all counts from that interval j. If j is the last interval, then the control unit 106 can include only part of the counts depending on where n is in j(n)—the portion into an interval can be referred to as offset into the interval. As a simplified example, consider three intervals (j ranges over 1, 2, 3), n is within interval 3 (e.g., J(n)=3), ñ₁=15, ñ₂=25, and ñ₃ is somewhere in between 0 and 20 (e.g., 9). Note that ñ₃ is not equal to the total count in interval 3 but is instead equal to an offset that represent n only partway into the third interval. If the control unit 106 calculated Σⱼ₌₁^{j(n)} ñj, this can represent the approximate total sales count until point n. However, in S (n|x(n, t, k), t, k) the control unit 106 determines how many sales are in each individual interval since the cumulative hazard on a particular interval depends on whether or not counts are summed over the whole interval or only summed over part of the interval (i.e., the offset).

In some implementations, the control unit 106 operates a threshold engine 138. In some implementations, the threshold engine 138 obtains one or more thresholds. In some implementations, the threshold engine 138 applies one or more thresholds to determine actions to be performed. For example, the threshold engine 138 can determine if a likelihood of a stock-out event satisfies a threshold likelihood.

In some implementations, the control unit 106 obtains additional data indicating a threshold to be applied by the threshold engine 138. For example, the control unit 106 can obtain the user data 110. The user data 110 can include user specified thresholds for stock-out risks. In some implementations, the user data 110 is obtained using a graphical interface—e.g., the interface shown in FIG. 2. The user data 110 can indicate a likelihood of stock-out that triggers one or more actions. For example, the user data 110 can indicate that a stock-out likelihood above 15%, determined by the one or more models generated by the model engine 132 (e.g., first model 134 or second model 136), causes a restocking of inventory to, in effect, decrease the likelihood of stock-out. Users can specify thresholds and, in this way, choose a risk tolerance level.

In some implementations, the inventory request engine 140 generates one or more inventory requests to adjust inventory available for services or manufacture. For example, the inventory request engine 140 can generate the inventory request 142. The inventory request engine 140 can transmit the inventory request 142 to the inventory system 144. The inventory system 144 can, in response to receiving the inventory request 142, produce the inventory 146 and provide the inventory 146 to the manufacturing plant 102 to be manufactured into articles to satisfy predicted levels of requests for the articles. The inventory system 146 can include one or more other manufacturing plants, material distributors, among others.

In some implementations, the inventory request 142 includes specific information for an inventory order. For example, specific information can include: one or more SKUs, timing for delivery, an amount of inventory to be delivered, among others.

In general, the techniques described can be used to determine: what to order (e.g., from the inventory system 144, specific SKUs, among others); when to order; and how much to order which is critical for the efficiency of both local and global supply chains. Optimal ordering decisions (e.g., “what”, “when”, and “how much”) from downstream nodes (such as, demand or orders from a retail store) can trigger upstream operations (e.g., delivery from distribution centers). For example, the inventory request engine 140, using output from the threshold engine 138, can generate instructions for inventory adjustment from one or more inventory systems—e.g., the inventory system 144. Data indicating demand or orders—e.g., included in the manufacturing data 104 or subsequent data—can trigger the control unit 106 to generate transmissions to systems for delivery of articles (e.g., from warehouses) or services (e.g., from worker firms, associations, or companies).

Thus, optimal ordering decisions from the control unit 106 can set in motion greater efficiency in the supply chain, such as, fleet or services logistics management (e.g., which trucks to be sent to which warehouse or distribution center, when a schedule of trucks is determined) and manufacturing (e.g., what should be produced, in what quantity).

FIG. 1 is described with reference to stages A through C. Although described in order from stage A through C, operations of the system 100 can occur in different orders or in parallel. For example, the control unit 106 can generate the inventory request 142, corresponding to stage C, while, before, or after, processing manufacturing data from the manufacturing plant 102 described in reference to stage A. Similarly, operations corresponding to stage B can be performed before one or more data items are obtained or processed by the control unit 106 or in parallel with obtaining one or more elements of manufacturing data from the manufacturing plant 102.

Although described in reference to manufacturing, the described techniques can be applied in other areas. For example, techniques for predicting an accounting for stock-out events can be used for any service where inventory is managed including a distributor who may not manufacture products but may plan to allocate inventory. Similarly, the techniques described can be used to allocate workers—e.g., truck drivers to satisfy a demand for truck shipments. In general, the techniques can be applied where demand can be represented as a monotonically increasing function and where inventory can be adjusted to satisfy the demand.

In some implementations, the model engine 132 generates one or more models for predicting demand. In some implementations, the model engine 132 generates one or more models for predicting arrival time. In some implementations, the control unit 106 obtains input from one or more application programming interfaces (APIs). For example, the control unit 106 can obtain data for input into one or more models generated by the model engine 132 from one or more APIs. In some implementations, the control unit 106 provides output to one or more APIs. For example, the control unit 106 can provide data obtained from one or more APIs to one or more models generated by the model engine 132. The control unit 106 can obtain output from the one or more models and provide the output as data to one or more APIs. In some implementations, predictions from one or more models are used to update one or more policies, e.g., for automated inventory management, delivery and pricing policies, holding cost policies, supply request policies, among others.

FIG. 2 is a visualization of a threshold system 200 for optimizing supply chains. In some implementations, the system 200 includes one or more user interfaces. For example, the system 200 can include an interface for displaying a probability 202 of stock-out events (e.g., from 0 to 1) where 0 probability corresponds to fewer inventory items compared to 1 which corresponds to greater inventory items. In some implementations, the system 100 includes one or more components for generating and providing the system 200 to a device.

In some implementations, the system 200 includes one or more representations of data generated by one or more data processing elements. For example, the system 200 can represent data generated by the control unit 106 or obtained from elements of the system 100. The system 200 can include inventory levels 204 (e.g., included in manufacturing data 104) for multiple types of inventory (e.g., current inventory and in-flight inventory). The system 200 can represent a probability of stocking-out for a variable amount of time (e.g., via an interface prompting a user to enter a time period specifying a period in the future for which a probability is calculated). The models generated by the model engine 132 can include a model to generate future inventory based on historic sales data. If inventory reaches 0, this can be considered a stock-out event. One or more models generated by the model engine 132 can predict a probability of such a stock-out event for the specified period of time entered by a user using input interface 206. Inputs to the models can include a current inventory level, historical data, contextual data (e.g., time of year, promotions, among others), and current upcoming orders. The probabilities can be represented to the user—e.g., using a plotted line, such as line 202.

In some implementations, the system 200 is used to obtain the user data 110. For example, the system 200 can obtain one or more thresholds for likelihoods of stock-out events specified by a user. The thresholds can then be used, e.g., by the threshold engine 138, to automatically generate and transmit order requests for additional inventory at a determined point in time or specifying future delivery according to predictions by the control unit 106.

In some implementations, the system 200 provides an interface 208 for selecting risk tolerance. For example, the interface 208 can include a sliding scale GUI element between 0 and 1 or 100, or other values. The value can represent a threshold for which to perform one or more re-stocking actions—such as generating and transmitting the inventory request 142. In the example of FIG. 2, the interface obtains a value of 90%. The 90% value represents a tolerance level for predictions made by one or more models, e.g., generated by the model engine 132. That is, a tolerance level of 90% indicates that a user is accepting a 10% change of inventory falling to 0. The threshold engine 138 can obtain such a threshold level and apply the threshold to subsequent predictions of stock-out events. If a probability of stock-out is above 10%, the threshold engine 138 can transmit an instruction to the inventory request engine 140 to generate and transmit an inventory request—such as the inventory request 142.

In some implementations, the system 200 includes a visualization of orders generated by the control unit 106. For example, the system 200 can generate a visualization of inventory ordered to fill a gap of inventory between a current probability of stock-out and an accepted risk of stock-out. That is, a current probability can be 30% (or 70% chance of not stocking-out) but an accepted risk can be 10% (e.g., selected using the interface 208). In order to adjust the probability, the inventory request engine 140 can generate and transmit the inventory request 142. For example, the inventory request 142 can include an indication of an amount and type of items or services corresponding to the inventory gap shown graphically in the system 200.

In some implementations, a visualization includes a graph visualization. For example, a graph visualization can include a directed graph where ‘nodes’ (e.g., ‘vertices’) and edges (e.g., ‘links’) represent, respectively, centers (nodes) in a supply chain network (SCN) and a ‘transportation’ route between two adjacent/connected nodes. In some implementations, the system 200 includes a directed graph visualization. For example, the system 200 can include one or more nodes and edges graphically depicted real world entities and relationships between the entities. A ‘node’ can include a structure that has a physical manifestation in the real world. Typical nodes in a SCN can include a supplier (e.g., an entity that provides raw material required by manufacturer(s) to produce a finished product); a manufacturer (e.g., an entity that processes raw material into an end product requested by the customer); a warehouse (e.g., an entity that stores and packs end products); a distribution center (e.g., an entity that plans and distributes product(s) to end customer); an end customer (e.g. a retail store, an entity that receives final product and sells to customers).

In some implementations, a directed graph included in the system 200 includes an indication of transportation. For example, in a SCN connectivity graph, every edge connecting two nodes can indicate an inflow or outflow of requested items via a transportation mode. Modes of transportation can include: 1. Ground (Truck) Transportation, 2. Freight Railroad Transportation, 3. Air Transportation, 4. Maritime Transportation. Any two nodes can be connected via more than one edge. For example, a distribution center in Atlanta (DC-1) can be connected to a customer center based in Houston (CT-3) via two edges (e.g., representing two modes of transportation): a) air transportation; b) railroad transportation.

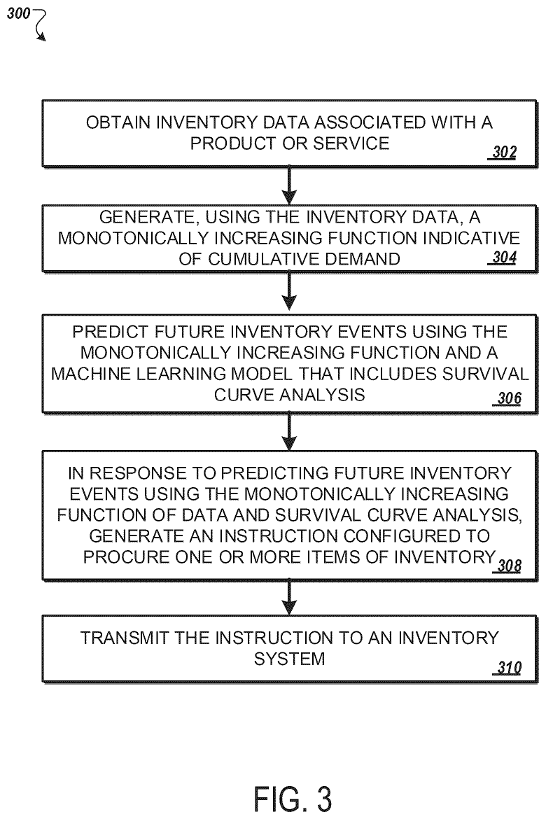

FIG. 3 is a flow diagram illustrating an example of a process 300 for automatically adjusting manufacturing or service inventory. The process 300 may be performed by one or more electronic systems, for example, the system 100 of FIG. 1.

The process 300 includes obtaining inventory data associated with a product or service (302). For example, the control unit 106 can obtain manufacturing data 104 from the manufacturing plant 102.

The process 300 includes generating, using the inventory data, a monotonically increasing function indicative of cumulative demand (304). For example, the control unit 106 can generate extracted data 126. The extracted data 126 can be stored in the training database 128 for training one or more machine learning models. The monotonically increasing function can be generated from inventory sales data included in the manufacturing data used to generate the extracted data 126 by the feature extraction engine 124.

The process 300 includes predicting future inventory events using the monotonically increasing function and a machine learning model that includes survival curve analysis (306). For example, the model engine 132 can obtain extracted data as training data 130 generated by the feature extraction engine 124. The model engine 132 provide the training data 130 to one or more untrained models to generate one or more trained models (e.g., model 134 and model 136). The training data 130 can include ground truth data in the form of known stock-out events or stock-out events predicted by the feature extraction engine 124 using one or more statistical techniques or additional machine learning models trained based on user feedback.

The process 300 includes in response to predicting future inventory events using the monotonically increasing function of data and survival curve analysis, generating an instruction configured to procure one or more items of inventory (308). For example, the threshold engine 138 can determine whether or not one or more generated probabilities of stocking-out satisfy one or more generated thresholds for stocking-out. If one or more thresholds are satisfied, the threshold engine 138 can provide an instruction to the inventory request engine 140 to generate the inventory request 142.

The process 300 includes transmitting the instruction to an inventory system (310). For example, the inventory request engine 140 can transmit the inventory request 142 to the inventory system 144.

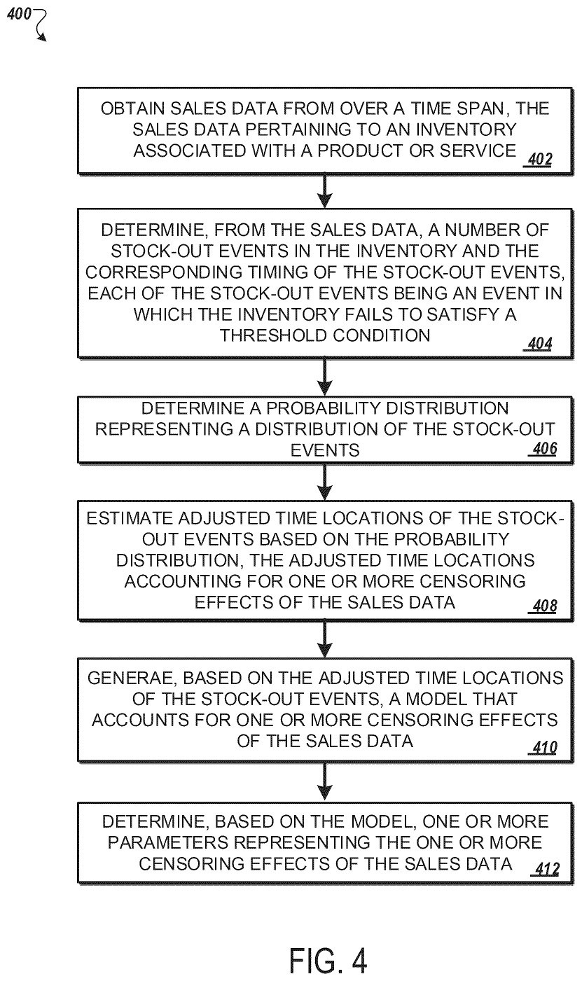

FIG. 4 is a flow diagram illustrating an example of a process 400 for optimizing supply chains. The process 400 may be performed by one or more electronic systems, for example, the system 100 of FIG. 1.

The process 400 includes obtaining sales data from over a time span, the sales data pertaining to an inventory associated with a product or service (402). For example, the control unit 106 can obtain manufacturing data 104 from the manufacturing plant 102.

The process 400 includes determining, from the sales data, a number of stock-out events in the inventory and the corresponding timing of the stock-out events, each of the stock-out events being an event in which the inventory fails to satisfy a threshold condition (404). For example, the feature extraction engine 124 can generate one or more stock-out events based on processing the manufacturing data 104 or previously obtained manufacturing data using one or more statistical techniques or additional machine learning models trained based on user feedback.

The process 400 includes determining a probability distribution representing a distribution of the stock-out events (406). For example, the feature extraction engine 124 can generate a probability distribution based on processing the manufacturing data 104 or previously obtained manufacturing data.

The process 400 includes estimating adjusted time locations of the stock-out events based on the probability distribution, the adjusted time locations accounting for one or more censoring effects of the sales data (408). For example, the feature extraction engine 124 can determine that demand for inventory is artificially suppressed because of a detected stock-out event. That is, inventory cannot be sold when there is no inventory to be sold despite there being demand. The feature extraction engine 124 can correct generated demand values (e.g., generated based on sales data) increasing historical demand values in regions after stock-out events have been predicted to occur. The amount of increase can depend on an extent of a stock-out event, where stock-out events from greater short term demand increases (e.g., many orders in an amount of time) result in greater augmented demand values compared to stock-out events from lesser demand increases (e.g., fewer orders in an amount of time).

The process 400 includes generating, based on the adjusted time locations of the stock-out events, a model that accounts for one or more censoring effects of the sales data (410). For example, the model engine 132 can generate one or more models, including the model 134 and the model 136. The generated one or more models can include models that represent smooth approximations of piece-wise functions, such as hazard functions and survival functions as described in this document. The generated one or more models can include a model that predicts stock-out events in manufacturing data when no explicit stock-out events have been indicated (e.g., data includes only inventory that was present or inventory that was sold over a period of time but does not include an indication of sales that were not made because inventory was insufficient to satisfy the order).

The process 400 includes determining, based on the model, one or more parameters representing the one or more censoring effects of the sales data (412). For example, the model engine 132 can train one or more models by adjusting one or more parameters. The one or more parameters can be adjusted to improve an accuracy of a model's prediction of stock-out events. In some implementations, the model engine 132 can obtain one or more ground truth items, including data representing known stock-out events. The model engine 132 can obtain prediction output and compare the output to the ground truth items. Using a comparison value representing a comparison between the output and the ground truth items (e.g., how many days off was the prediction of a stock-out event compared to the known stock-out event), the model engine 132 can adjust one or more parameters of a model. Techniques such as backpropagation can be used by the model engine 132 to adjust or determine one or more parameters. A resulting trained model can be used by the feature extraction engine 124 to augment data to be processed in a model for predicting the likelihood of future stock-out events using approximations of hazard functions or survival curve analysis.

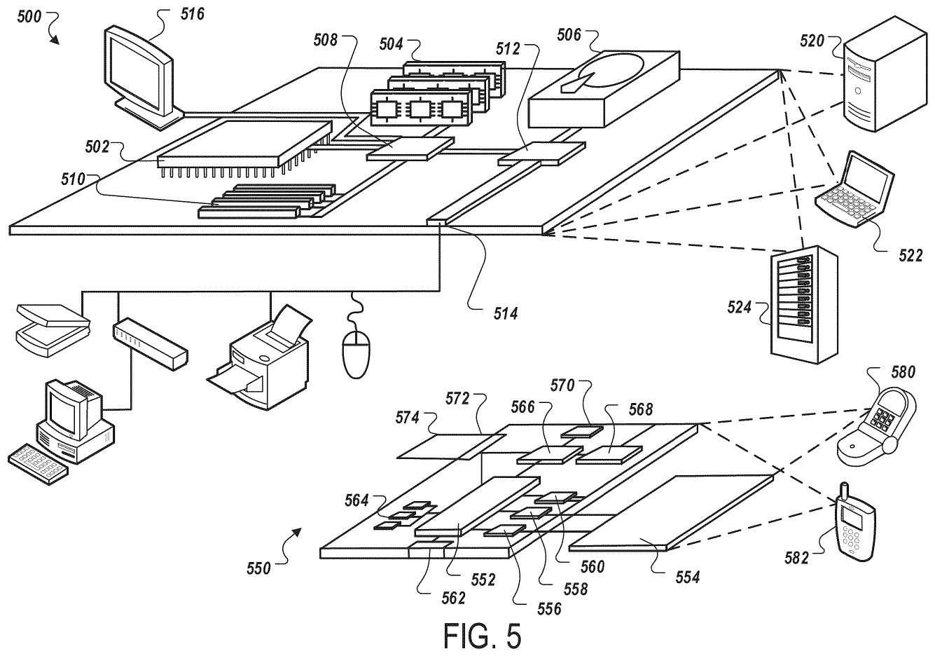

FIG. 5 is a diagram illustrating an example of a computing system used for automatically adjusting manufacturing or service inventory or optimizing supply chains. The computing system includes computing device 700 and a mobile computing device 750 that can be used to implement the techniques described herein. For example, one or more components of the system 100 could be an example of the computing device 700 or the mobile computing device 750, such as a computer system implementing the control unit 106, devices that access information from the control unit 106, or a server that accesses or stores information regarding the operations performed by the control unit 106.

The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 702 is a single threaded processor. In some implementations, the processor 702 is a multi-threaded processor. In some implementations, the processor 702 is a quantum computer.

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine readable mediums (for example, the memory 704, the storage device 706, or memory on the processor 702). The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device, such as a mobile computing device 750. Each of such devices may include one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 752), perform one or more methods, such as those described above. The instructions can also be stored by one or more storage devices, such as one or more computer-or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry in some cases. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 768 using a radio frequency. In addition, short-range communication may occur, such as using a Bluetooth, Wi-Fi, or other such transceiver (not shown). In addition, a GPS (Global Positioning System) receiver module 770 may provide additional navigation-and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, among others) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method for automatically adjusting manufacturing or service inventory, the method comprising:
obtaining inventory data associated with a product or service;
generating, using the inventory data, a monotonically increasing function indicative of cumulative demand;
predicting future inventory events using the monotonically increasing function and a machine learning model that includes survival curve analysis;
in response to predicting future inventory events using the monotonically increasing function of data and survival curve analysis, generating an instruction configured to procure one or more items of inventory; and
transmitting the instruction to an inventory system.

2. The method of claim 1, wherein inventory events comprise a stock-out event in which an inventory level fails to satisfy a threshold condition.

3. The method of claim 2, comprising:
generating, using the inventory data, past stock-out event predictions, wherein the past stock-out event predictions comprise a time value indicating when a past stock-out event occurred.

4. The method of claim 3, wherein predicting future inventory events using the monotonically increasing function of data and the machine learning model that includes survival curve analysis comprises:
providing the past stock-out event predictions to the machine learning model trained to determine a likelihood of future stock-out events.

5. The method of claim 1, comprising:
determining to generate the instruction configured to procure the one or more items of inventory.

6. The method of claim 5, comprising:
generating, using output from the machine learning model, a likelihood of a future stock-out event for a period of time in the future; and
comparing the likelihood of a future stock-out event for the period of time in the future with a user-defined target likelihood, the target likelihood being indicative of an associated risk tolerance level, wherein determining to generate the instruction configured to procure the one or more items of inventory comprises:
determining the likelihood of a future stock-out event for the period of time in the future is higher than the target likelihood.

7. The method of claim 1, comprising:
providing a user interface indicating a likelihood of a future stock-out event for a period of time in the future and a risk tolerance level provided by a user;
obtaining input from the user interacting with the user interface indicating a change in the period of time; and
updating the user interface indicating the cumulative likelihood of a future stock-out event for the changed period of time in the future and the risk tolerance level provided by the user.

8. A computer-implemented method comprising:
obtaining sales data from over a time span, the sales data pertaining to an inventory associated with a product or service;
determining, from the sales data, a number of stock-out events in the inventory and the corresponding timing of the stock-out events, each of the stock-out events being an event in which the inventory fails to satisfy a threshold condition;
determining a probability distribution representing a distribution of the stock-out events;
estimating adjusted time locations of the stock-out events based on the probability distribution, the adjusted time locations accounting for one or more censoring effects of the sales data;
generating, based on the adjusted time locations of the stock-out events, a model that accounts for one or more censoring effects of the sales data; and
determining, based on the model, one or more parameters representing the one or more censoring effects of the sales data.

9. The method of claim 8, wherein determining the probability distribution representing the distribution of the stock-out events comprises using one or more hyperprior distributions to determine the probability distribution.

10. The method of claim 8, wherein estimating the adjusted time locations of the stock-out events comprises determining a time period between at least two of the stock-out events.

11. The method of claim 8, wherein the probability distribution comprises at least one of an exponential distribution or a Poisson distribution.

12. The method of claim 8, wherein determining the probability distribution comprises adjusting one or more parameters of the probability distribution based on user-input.

13. The method of claim 8, wherein the model comprises a generative Bayesian model.

14. The method of claim 8, wherein the model is adjusted based on additional sales data.

15. The method of claim 14, wherein the model is adjusted based on additional sales data using techniques that include at least one of (i) Markov Chain Monte Carlo technique or (ii) Variational Inference.

16. The method of claim 8, wherein the model includes a posterior distribution representing a corresponding quantity of interest.

17. The method of claim 16, wherein the corresponding quantity of interest is one of (i) a number of the stock-out events, (ii) a timing of the stock-out events, or (iii) an estimate of a true demand during the time span.

18. A system comprising one or more computers and one or more storage devices on which are stored instructions that are operable, when executed by the one or more computers, to cause the one or more computers to perform operations comprising:
obtaining inventory data associated with a product or service;
generating, using the inventory data, a monotonically increasing function indicative of cumulative demand;
predicting future inventory events using the monotonically increasing function and a machine learning model that includes survival curve analysis;
in response to predicting future inventory events using the monotonically increasing function of data and survival curve analysis, generating an instruction configured to procure one or more items of inventory; and
transmitting the instruction to an inventory system.

19. The system of claim 18, wherein inventory events comprise a stock-out event in which an inventory level fails to satisfy a threshold condition.

20. The system of claim 19, comprising:
generating, using the inventory data, past stock-out event predictions, wherein the past stock-out event predictions comprise a time value indicating when a past stock-out event occurred.
